(19) United States
(12) Patent Application Publication
(10) Pub. No.: US 2007/0133008 A1
(43) Pub. Date: Jun. 14, 2007

(54) Optical fiber delivered reference beam for interferometric imaging

(75) Inventors: Alex Klooster, Ann Arbor, MI (US); Carl C. Aleksoff, Dexter, MI (US)

Correspondence Address: SCHOX PLC, 209 N. MAIN STREET #200, ANN ARBOR, MI, 48104, US

(73) Assignee: Coherix, Inc., Ann Arbor, MI (US)

(21) Appl. No.: 11/299,548

(22) Filed: Dec. 12, 2005

(51) Int. Cl. G01B 9/02; G01B 11/02

(52) U.S. Cl. 356/512; 356/477

(57) ABSTRACT

An optical fiber is used to deliver a reference beam in an interferometric imaging system having an off-axis paraboloid collimating and imaging mirror. A controllable fiber optic beam splitter controls the ratio of light from an optical fiber delivered to an object illumination beam and to the reference beam.

### FIELD OF THE INVENTION

The field of the invention is the field of measuring surface topography of an object.

### BACKGROUND OF THE INVENTION

Interferometry has been used for over a century to measure the surface topography of objects, typically optical components, and distances and small changes in such distances. With the advent of lasers having long coherence lengths and high brightness, the field has expanded greatly. Interferometric comparison of objects with a known surface, as depicted by FIG. 1, has been difficult to implement for very large objects with surfaces with steps or slopes greater than a half wavelength of light per resolution element of the imaging system, because the phase count is lost, and the height of the object surface is known only modulo λ/2, where λ is the wavelength of light used for the interferometer.

If a series of imaging interferograms are recorded with different wavelengths λᵢ, the ambiguity in the phase may be resolved, and the heights on the object surface relative to a particular location on the particle surface may be calculated, as is shown in the patents cited below.

### RELATED PATENTS AND APPLICATIONS

U.S. Pat. No. 5,907,404 by Marron, et al. entitled “Multiple wavelength image plane interferometry” issued May 25, 1999;

U.S. Pat. No. 5,926,277 by Marron, et al. entitled “Method and apparatus for three-dimensional imaging using laser illumination interferometry” issued Jul. 20, 1999;

U.S. patent application Ser. No. 10/893,052 filed Jul. 16, 2004 entitled “Object imaging system using changing frequency interferometry method” by Michael Mater;

U.S. patent application Ser. No. 10/349,651 filed Jan. 23, 2003 entitled “Interferometry method based on changing frequency” by Michael Mater;

U.S. patent application Ser. No. 11/181,664 filed Jul. 14, 2005 by inventors Jon Nisper, Mike Mater, Alex Klooster, Zhenhua Huang entitled “A method of combining holograms”;

U.S. patent application Ser. No. 11/194,097 filed Jul. 29, 2005 by inventor Mike Mater et. al entitled “Method for processing multiwavelength interferometric imaging data”.

A US patent application filed the same day as the present application, listing the same inventors, and entitled “Off-axis paraboloid interferometric mirror with off focus illumination”.

The above identified patents and patent applications are assigned to the assignee of the present invention and are incorporated herein by reference in their entirety including incorporated material.

### OBJECTS OF THE INVENTION

It is an object of the invention to produce an interferometric system for investigating, imaging, and measuring the topography of the surfaces of large objects.

It is an object of the invention to produce an interferometric system having lighter and less expensive optical elements.

It is an object of the invention to produce an interferometric system having an easily variable ratio of objet illumination intensity to reference beam intensity.

### SUMMARY OF THE INVENTION

An optical fiber is used to deliver a reference beam directly to an image receiver in an interferometric imaging system. An optical fiber is also used to illuminate the object in the interferometric imaging system. A controllable optical fiber beamsplitter is used to split light intensity carried in one fiber between the reference and illumination optical fibers.

### BRIEF DESCRIPTION OF THE DRAWINGS

FIG. 1 shows a sketch of a prior art interferometer.

FIG. 2 shows a sketch of a prior art imaging interferometer.

FIG. 3 shows a sketch of an imaging interferometer of the invention.

FIG. 4 shows a phase changing apparatus of the invention.

FIG. 5 shows a phase changing apparatus of the invention

### DETAILED DESCRIPTION OF THE INVENTION

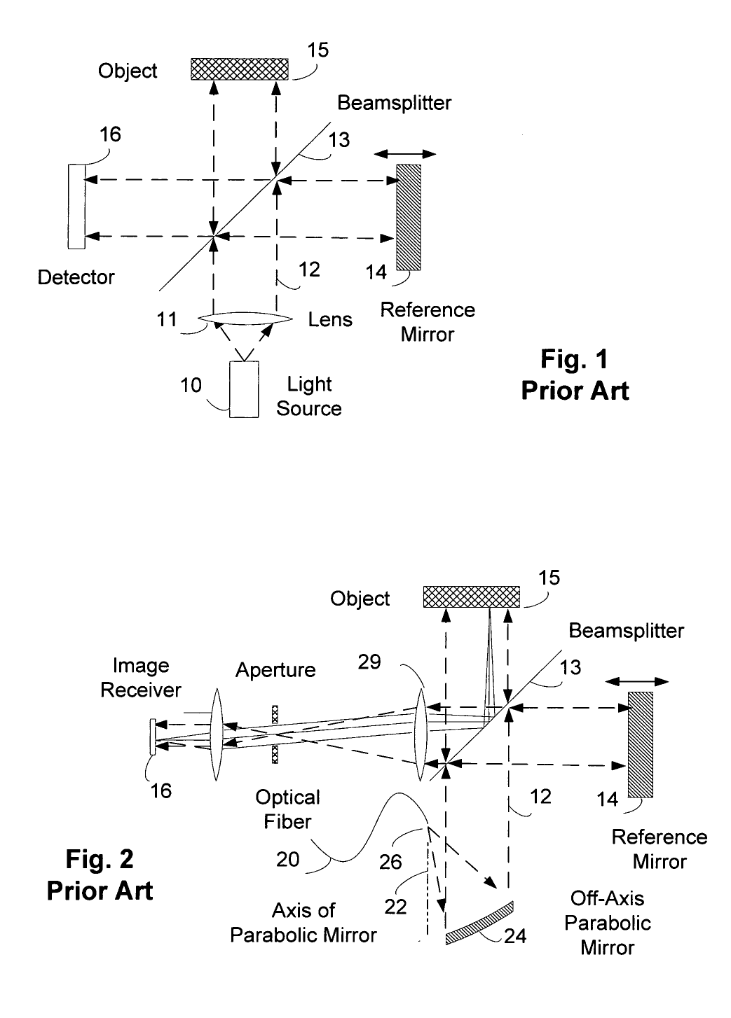

FIG. 1 shows a sketch of a prior art interferometer. The particular interferometer shown in FIG. 1 is conventionally called a Michelson interferometer, and has been used since the nineteenth century in optical experiments and measurements. A light source 10 produces light which is collimated by passing through a lens system 11 to produce a parallel beam of light 12 which passes to a beamsplitter 13. The beam of light 12 is partially reflected to a reference mirror 14 and partially transmitted to an object 15. Light reflected from the reference mirror 14 partially passes through the beamsplitter to an image receiver 16. Light reflected from the object is partially reflected from the beamsplitter 15 and is passed to the image receiver 16. The image receiver 16 may be film, or may be an electronic photodetector or a CCD or a CMOS array, or any other image receiver known in the art.

If both the reference mirror 14 and the object 15 are flat mirrors aligned perpendicular to the incoming light from beam 12, and the light path traversed by the light from the light source to the image receiver is identical, the light from both the reference mirror and the object mirror will be in phase, and the image receiver will show a uniformly bright image. Such devices were the bane of undergraduate optics students before the advent of lasers, since the distances had to be equal to within distances measured by the wavelength of the light and the mirrors had to be aligned within microradians. Even with the advent of lasers with very long coherence lengths, such devices are subject to vibration, thermal drift of dimensions, shocks, etc.

However, the Michelson interferometer design of FIG. 1 is useful to explain the many different types of interferometers known in the art. In particular, suppose the reference mirror 14 is moved back and forth in the direction of the arrow in FIG. 1. As the reference mirror is moved, the phase of the light beam reflected from the reference mirror and measured at the image receiver 16 will change by 180 degrees with respect to the phase of the light reflected from the object 15 for every displacement of one quarter wavelength. The light from the two beams reflected from the object 15 and the reference mirror 14 will interfere constructively and destructively as the mirror moves through one quarter wavelength intervals. If the intensity of both the reference and object beams are equal, the intensity at the image receiver will be zero when the mirrors are positioned for maximum destructive interference. Very tiny displacements of one of the mirrors 14 or 15 can thus be measured.

FIG. 2 shows a sketch of an prior art imaging interferometer much like the interferometer of FIG. 1, except that the light source does not use a lens to collimate the light into a parallel beam 12. Instead, an off-axis parabolic mirror 24 is used to reflect the light output 26 of an optical fiber 20 into a parallel beam of light 12. Mirror 24 is a section having a reflecting surface which is part of a parabola of revolution about the axis 22. The end of the optical fiber 20 is placed on the axis 22 at or very near the focal point P of the parabolic mirror, ie. the point to which a parallel light beam parallel to light beam the axis 22 (which is the optical axis of the parabolic mirror) coming in to and reflected from the mirror 24 would be focused. The optical fiber 20 may incorporate a lens system (not shown) which appears to diverge the beam of light from the focal point P. An optical system (shown symbolically as lenses 28 and 29) is shown for imaging the surface of the object 15 on to the image receiver 16. The optical system 29 and image receiver 15 are incorporated in the most preferred embodiment of the invention as a camera, where the image size of the object 15 on the image receiver may be much smaller than the size of the object 15. The optical set up sketched in FIG. 2 is shown as a telecentric optical system, where diverging light rays 25 scattered from a point on the surface of the object 15 diverge until they pass through lens 29, then travel parallel to each other through an aperture 27, and are converged again to a point on the surface of the image receiver 16.

The term off-axis parabolic mirror is used in this specification to mean that the part of the parabolic mirror used in the optical system is off the optical axis of the parabola. Clearly, if the part of the light from the optical fiber 26 struck a parabola on axis 22, that light would be directed back to the focal point P and would not be available for use in the interferometer because of shadowing of the fiber. The light beam 26 is shown diverging from the end of the fiber 20, but a lens system (not shown) is anticipated for controlling the divergence of the light exiting the optical fiber 20. Preferably, the light beam 26 fills the entire aperture of the off-axis paraboloid 24, or at least enough of the area of mirror 24 so that the entire field of interest of the surface of the object 15 is illuminated by the parallel beam of light 12.

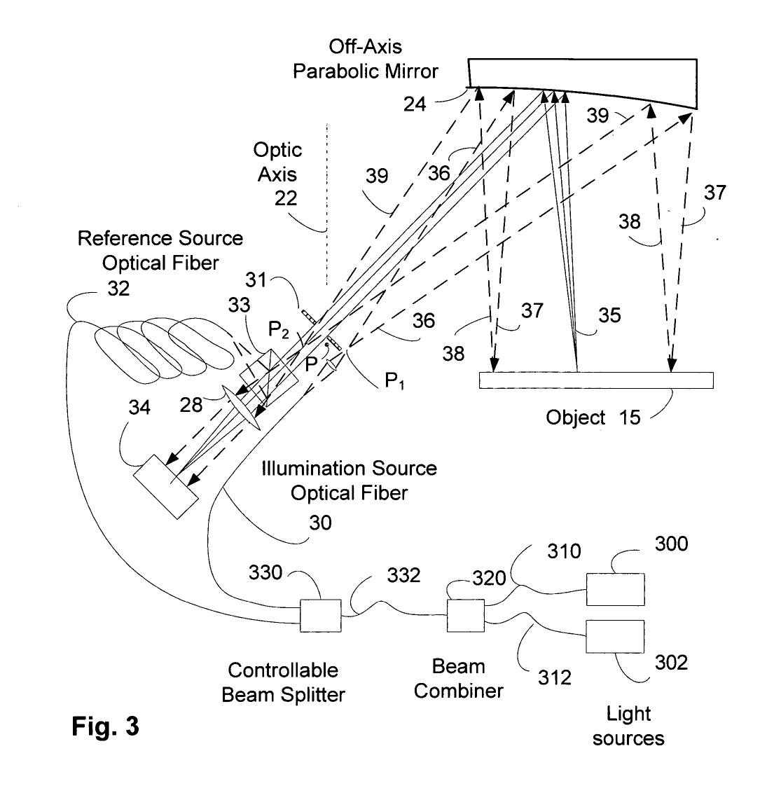

FIG. 3 shows a sketch of a preferred embodiment of the invention, where the large reference mirror 14 and the large beam splitter 13 are no longer needed. Light 36 from an object illumination fiber source 30 is shown diverging from a first point P₁ apart from the focus point P of the parabolic mirror. The light travels to the paraboloid and is reflected as a nearly parallel beam 37 which falls on the surface of the object 15. Since the point P₁ is apart from the focus point P of the paraboloid, the parallel light beam represented by 37 is not parallel to the optical axis 22 of the parabolic mirror. Light 38 is shown as a parallel beam reflecting from a surface of the object 15, where the surface is perpendicular to the optical axis 22. Parallel light beam 38 reflects again from the parabolic mirror 24, and is then brought to a focus at a point P₂ which is symmetrically located with respect to the focal point P from point P₁. An optional aperture 31 limits the light scattered from the object surface 15, and light 39 is combined with light from a reference light carrying fiber source 32 by a small partially reflecting beamsplitter 33. Light scattered from a point on the surface of the object is shown as a bundle of rays 35. A image receiver 34 captures the image of the surface of the object 15 and displays an interferometric phase image of the object surface. A computer (not shown) captures and displays phase images of the surface at different relative phases between the reference source 32 and the object illumination source 30 and different wavelengths of light from the reference source 32 and the object illumination source 30, and constructs synthetic phase images and holograms from the data as detailed in the referenced patents and patent applications.

The object 15 is shown in FIG. 3 as being approximately a focal distance of the parabolic mirror 24 from the parabolic mirror, so that the diverging light bundle 25 is collimated into a parallel beam which passes through aperture 31 on its way to being focused on the image receiver. However, the system as shown is still useful for mirror object distances different from the focal length of mirror 24, since the position of 28 may be changed to refocus the light 35 on to the image receiver 34.

The object illumination source 30 is a fiber optic light source, where a laser light source, a diode laser source, an optical fiber laser, a light emitting diode, or an arc or incandescent light source is input to the optical fiber. The object illumination fiber source 30 may be a fixed frequency light source, a tunable frequency light source, or indeed, a number n of light sources with either fixed or tunable frequencies.

FIG. 3 shows a novel method of combining and splitting light carried in optical fibers for use in an interferometric imaging system. One or might light sources 300 and 302 feed light into optical fibers 310 and 312. An optional beam combiner 320 combines the output from fibers 310 and 312 and outputs the light to optical fiber 322. A beam splitter 330 splits the light from fiber 330 into the illumination source fiber 30 and the reference source fiber 32. Optionally, the beam splitter 330 is a controllable beam splitter, where the percentage of the light in optical fiber 322 delivered to fibers 30 and 32 may be varied. The controllable beam splitter is very valuable when the objects 15 investigated change often, and have different reflectivity, color, and surface scattering coefficients. The imaging system described in the above referenced applications and patents works best when the amplitude of the reference beam and the amplitude of the light scattered from the object measured at the image receiver are comparable, so that the variation of the resultant intensity as measured by the image receiver is comparable with the intensity of the reference or object beams alone as the relative phases of object and reference beam are changed.

The controllable beam splitter is very valuable when the objects 15 investigated change often, and have different reflectivity, color, and surface scattering coefficients. When changing from a object having a high degree of backscattering of the object illumination beam to a more absorbing object or more diffusely scattering object, the proportion of the light carried by fiber 322 is changed by controllable beam splitter 330 to put more light into fiber 30 and less into fiber 32. The total amount of light falling on the image receiver will drop, but the gain of the image receiver or the total amount of power carried by fiber 322 is raised, and the amplitude variation of the interference intensity remains constant.

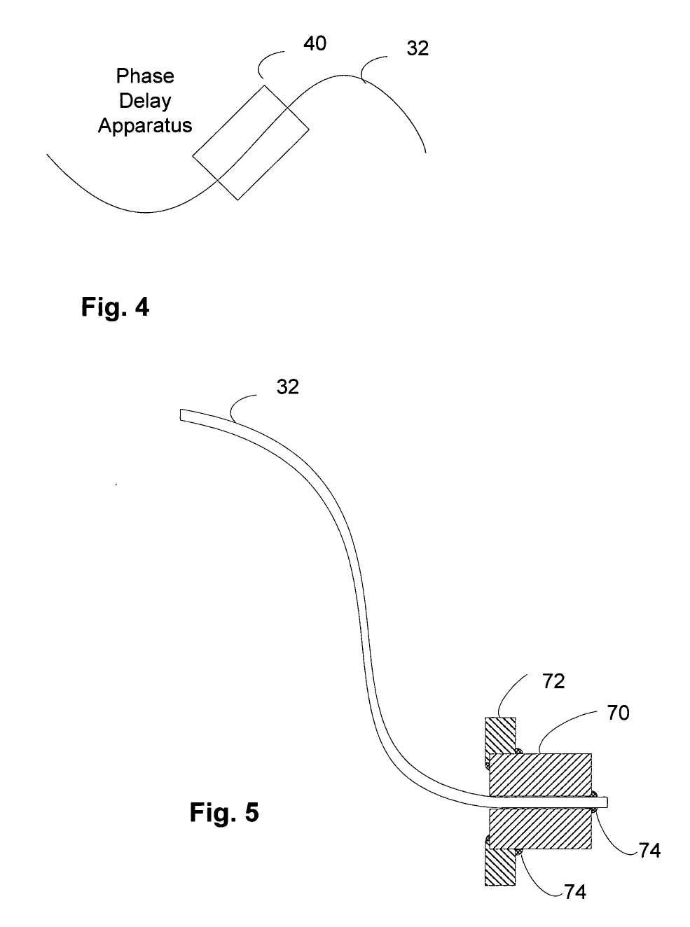

The reference illumination source 32 may be an optical fiber which contains a means to change the phase of the reference light with respect to light from the source 30. FIG. 4 shows an optical fiber 32 having a phase delay apparatus 40 for changing the relative phase. A commercial device which stretches the optical fiber 32 has been found to work well.

FIG. 5 shows a the most preferred method of introducing a relative phase change in an reference optical fiber source. Optical fiber 32 is held by an adhesive 74 to one end of a piezo electric tube 70. The other end of the tube 70 is joined to a base 72 which is fixed with respect to the optical system. Applying a voltage to the piezo tube (electrodes and voltage generators and wires not shown) lengthens tube 70 and easily changes the relative phase by a few wavelengths.

Obviously, many modifications and variations of the present invention are possible in light of the above teachings. It is therefore to be understood that, within the scope of the appended claims, the invention may be practiced otherwise than as specifically described.

We claim:

1. An interferometric imaging system for imaging the surface of an object introduced into the interferometric imaging system, comprising:
one or more light sources;
one or more first optical fiber object illumination sources receiving light from the one or more light sources;
an off axis paraboloid mirror receiving light from the one or more first optical fiber object illumination sources, wherein the light from the one or more first optical fiber object illumination sources reflecting from the off axis paraboloid mirror forms a nearly parallel beam of light for illumination of the surface of the object;
an image receiver;
an optical system for receiving light reflected from the surface of the object to form an image of the surface of the object onto the image receiver; and
a second optical fiber reference illumination source for illuminating the surface of the image receiver with a reference beam having a defined phase with respect to the light from the one or more optical fiber object illumination sources, wherein light from the second optical fiber reference illumination system and light from the optical system for imaging the surface of the object onto the image receiver co-operate to form a phase image of the object on the image receiver.

2. The interferometric imaging system of claim 1, further comprising;
a computer system for receiving phase images from the image receiver and constructing a synthetic phase image of the object.

3. The interferometric imaging system of claim 1, further comprising;
a device for dividing light carried by a third optical fiber into at least two optical fibers, wherein one optical fiber is the optical fiber of the optical fiber reference illumination source and one optical fiber is an optical fiber of the optical fiber object illumination source.

4. The interferometric imaging system of claim 3, wherein the device for dividing light is a controllable device wherein the ratio of the light carried by the optical fiber of the optical fiber object illumination source and the optical fiber of the optical fiber reference illumination source is controllable.

5. The interferometric imaging system of claim 4, further comprising a device for controlling the relative phase of the light produced by the optical fiber object illumination source and the optical fiber reference illumination source.

6. The interferometric imaging system of claim 5, wherein the device for controlling the relative phase is an optical fiber stretching device.

7. The interferometric imaging system of claim 5, wherein the device for controlling the relative phase is device for moving an end of an optical fiber.

8. The interferometric imaging system of claim 3, further comprising a device for controlling the relative phase of the light produced by the optical fiber object illumination source and the optical fiber reference illumination source.

9. The interferometric imaging system of claim 8, wherein the device for controlling the relative phase is an optical fiber stretching device.

10. The interferometric imaging system of claim 8, wherein the device for controlling the relative phase is device for moving an end of an optical fiber.

11. An apparatus, comprising;
an interferometric imaging system for imaging the surface of an object introduced into the interferometric imaging system, comprising:
an off axis paraboloid mirror receiving light from one or more optical fiber object illumination sources, wherein the light from the one or more first optical fiber object illumination sources reflecting from the off axis paraboloid mirror forms a nearly parallel beam of light for illumination of the surface of the object;
an optical system for receiving light reflected from the surface of the object to form an image of the surface of the object onto an image receiver; and
a second optical fiber reference illumination source for illuminating the surface of the image receiver with a reference beam having a defined phase with respect to the light from the one or more optical fiber object illumination sources, wherein light from the second optical fiber reference illumination system and light from the optical system for imaging the surface of the object onto the image receiver co-operate to form a phase image of the object on the image receiver.
